(19) United States
(12) Patent Application Publication
(10) Pub. No.: US 2005/0241340 A1
(43) Pub. Date: Nov. 3, 2005

(54) Core insert for glass molding machine and method for making same

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD, Taipei (TW)

(21) Appl. No.: 11/093,216

(22) Filed: Mar. 29, 2005

(30) Foreign Application Priority Data
Apr. 30, 2004 (TW) 93112193

(51) Int. Cl. C03B 40/02

(52) U.S. Cl. 65/169; 65/26

(57) ABSTRACT

A core insert for a glass molding machine includes a substrate and a protective film. The substrate is made of ceramic, such as tungsten carbide (WC), carborundum (SiC), silicon nitride (Si₃N₄), or boron nitride carbide (BNC). The protective film is deposited on a surface of the substrate, and the protective film is made of a fullerene (C₆₀ or C₇₀). The core insert has good adhesion between the substrate and the protective film, because the fullerene has good adhesion with the ceramic material. Thus the core insert has a long working lifetime. A method for making the core insert is also provided.

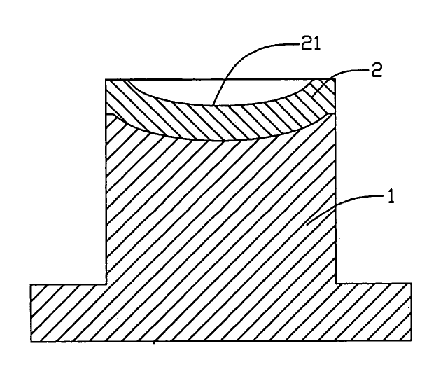

### BACKGROUND OF THE INVENTION

1. Field of the Invention

The present invention generally relates to glass molding machines, and more particularly to a core insert for a glass molding machine.

2. Prior Art

Currently, digital camera modules are included as a feature in a wide variety of portable electronic devices. Most portable electronic devices are becoming progressively more miniaturized over time, and digital camera modules are correspondingly becoming smaller and smaller. Nevertheless, in spite of the small size of a contemporary digital camera module, consumers still demand excellent imaging. Image quality of a digital camera is mainly dependent upon the optical elements of the digital camera module.

Aspheric lenses are very important elements in the digital camera module. Contemporary aspheric lenses are manufactured by way of glass molding. The glass molding machine operates at a high temperature and high pressure during the glass molding process. Therefore, core inserts are needed, and must be accurately designed and manufactured. The core inserts should have excellent chemical stability in order not to react with the glass material. In addition, the core inserts also should have enough rigidity and excellent mechanical strength in order not to be scratched. Furthermore, the core inserts should be impact-resistant at high temperatures and high pressures. Moreover, the core inserts must have excellent machinability, in order for them to be machined precisely and easily to form the desired optical surfaces. Finally, the core inserts must have a long working lifetime so that the cost of manufacturing aspheric lenses is reduced.

A typical contemporary core insert comprises a substrate and a protective film. The substrate is made of stainless steel, carborundum (SiC), or tungsten carbide (WC). The protective film is made of diamond-like carbon film (DLC), noble metals, or alloys of noble metals. The noble metals can be platinum (Pt), iridium (Ir) or ruthenium (Ru). The alloys of noble metals can be iridium-ruthenium (Ir—Ru), platinum-iridium (Pt—Ir), or iridium-rhenium (Ir—Re). The diamond-like carbon film has a short working lifetime. The noble metals or alloys of noble metals have good chemical stability, rigidity and heat-resistance. Nevertheless, the protective film made of noble metals or alloys of noble metals has poor adhesion with the substrate. Thus the core insert generally has a short working lifetime, which escalates the cost of producing aspheric lenses.

Therefore, a core insert for a glass molding machine which overcomes the above-described problems is desired.

### SUMMARY OF THE INVENTION

Accordingly, an object of the present invention is to provide a core insert which has good adhesion between a substrate and a protective film thereof, and which has a long working lifetime.

Another object of the present invention is to provide a method for making the above-described core insert.

To achieve the first of the above objects, a core insert for a glass molding machine comprises a substrate and a protective film. The substrate is made of ceramic, such as tungsten carbide (WC), carborundum (SiC), silicon nitride (Si₃N₄), or boron nitride carbide (BNC). The protective film is deposited on a surface of the substrate, and the protective film is made of a fullerene (C₆₀ or C₇₀). The core insert has good adhesion between the substrate and the protective film because the fullerene has good adhesion with the ceramic material. Thus the core insert has a long working lifetime.

To achieve the second of the above objects, a method for making a core insert comprises the steps of: providing a substrate, the substrate being made of ceramic, such as tungsten carbide (WC), carborundum (SiC), silicon nitride (Si₃N₄), or boron nitride carbide (BNC); and depositing a protective film on a surface of the adhesive film, the protective film being made of a fullerene (C₆₀ or C₇₀); wherein the fullerene is deposited on the substrate by way of electron-beam evaporation or ion-beam evaporation.

Other objects, advantages and novel features of the invention will become more apparent from the following detailed description when taken in conjunction with the accompanying drawing, in which:

### BRIEF DESCRIPTION OF THE DRAWINGS

The drawing is a cross-sectional view of a core insert in accordance with a preferred embodiment of the present invention.

### DETAILED DESCRIPTION OF THE INVENTION

Referring to the drawing, in a preferred embodiment of the present invention, a core insert for a glass molding machine comprises a substrate 1 and a protective film 2. The protective film 2 is deposited on a surface of the substrate 1. The protective film 2 has a concave surface 21. The substrate 1 is made of ceramic, such as tungsten carbide (WC), carborundum (SiC), silicon nitride (Si₃N₄), or boron nitride carbide (BNC). The protective film 2 is made of a fullerene (C₆₀ or C₇₀).

A method of the present invention for making a core insert comprises the steps of: providing a substrate 1 made of ceramic, such as tungsten carbide (WC), carborundum (SiC), silicon nitride (Si₃N₄), or boron nitride carbide (BNC); and depositing a protective film 2 on a surface of the substrate 1, the protective film 2 being made of a fullerene (C₆₀ or C₇₀). The fullerene can be manufactured by way of graphite arc discharge. The fullerene is deposited on the substrate 1 by way of electron-beam evaporation or ion-beam evaporation. The protective film 2 is preferably 20-100 nm thick.

When the fullerene is manufactured by way of graphite arc discharge, this comprises the steps of: providing a vacuum system with a carbon anode and a cathode; adding some metallic catalyst in the middle of the carbon anode, wherein the metallic catalyst can be iron (Fe), cobalt (Co), or nickel (Ni); evacuating the vacuum system; introducing some inert gas (argon or krypton) into the vacuum system; applying a driving voltage (15-30V) and a driving current (50-130A) between the carbon anode and the cathode; slowly moving the carbon anode toward the cathode at an even speed until an arc with high temperature (about 4000° K) appears between the carbon anode and the cathode, whereby carbon of the carbon anode is vaporized and deposited on the cathode, the deposition on the cathode being in the form of a fullerene (C₆₀ or C₇₀). The fullerene is subsequently purified, and then deposited on a surface of the substrate 1 by way of electron-beam evaporation or ion-beam evaporation.

The core insert of the present invention has been tested in glass molding procedures at a temperature of 450-500° C. and a pressure of 7000 N (newtons). After 10,000 such cycles, the core insert still had a good surface, and the protective film 2 had not worn off.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A core insert for a glass molding machine, comprising:
a substrate made of ceramic; and
a protective film deposited on a surface of the substrate, the protective film being made of a fullerene.

2. The core insert as claimed in claim 1, wherein the ceramic is a material selected from the group consisting of tungsten carbide (WC), carborundum (SiC), silicon nitride (Si₃N₄), and boron nitride carbide (BNC).

3. The core insert as claimed in claim 1, wherein the protective film is 20-100 nm thick.

4. The core insert as claimed in claim 1, wherein the fullerene is C₆₀ or C₇₀.

5. The core insert as claimed in claim 1, wherein the protective film has a concave surface.

6. A method for making a core insert, comprising the steps of:
providing a substrate, the substrate being made of ceramic; and
depositing a protective film on a surface of the substrate;
wherein the protective film is made of a fullerene, and the protective film is deposited by means of electron-beam evaporation or ion-beam evaporation.

7. The method according to claim 6, wherein the fullerene is C₆₀ or C₇₀.

8. The method according to claim 7, wherein the fullerene is manufactured by means of graphite arc discharge.

9. The method according to claim 6, wherein the ceramic is selected from the group consisting of tungsten carbide (WC), carborundum (SiC), silicon nitride (Si₃N₄), and boron nitride carbide (BNC).
